(19) United States
(12) Patent Application Publication
(10) Pub. No.: US 2011/0068542 A1
(43) Pub. Date: Mar. 24, 2011

(54) SEALING DEVICE

(75) Inventor: Takehiro Nakagawa, Fukushima (JP)

(73) Assignee: NOK CORPORATION, Tokyo (JP)

(21) Appl. No.: 12/992,966

(22) PCT Filed: Jun. 4, 2009
(86) PCT No.: PCT/JP2009/060217

§ 371 Date: Nov. 16, 2010

(30) Foreign Application Priority Data
Jun. 9, 2008 (JP) 2008-150030

(51) Int. Cl. F16J 15/16

(52) U.S. Cl. 277/549

(57) ABSTRACT

A sealing device has a sealing device main body (1), in which a seal lip (13) oriented to an in-machine (A) side slidably contacts with the outer peripheral surface of a rotating body (4), and a pumping device (2) having a helical groove (2a) which feeds fluid to the seal lip (13) side by rotation of the rotating body (4), the groove being formed in a surface opposed to the outer peripheral surface of the rotating body (4) to be positioned at the in-machine (A) side of the seal lip (13), and discharge flow passages (2b) which make a space (C) between the sealing device main body (1) and the pumping device (2) communicate with the in-machine (A) side, whereby sufficient lubricating oil can be supplied to a sliding portion of the seal lip and heat generation and the wear of the seal lip can be suppressed.

### CROSS-REFERENCE TO RELATED APPLICATIONS

This is a national stage of International Application No. PCT/JP2009/060217 filed on Jun. 4, 2009 and published in the Japanese language. This application claims the benefit of Japanese Patent Application No. 2008-150030 filed on Jun. 9, 2008. The disclosures of the above applications are incorporated herein by reference.

### BACKGROUND OF THE INVENTION

1. Field of the Invention

The present invention relates to a sealing device sealing an outer periphery of a rotating body in a motor vehicle, a general machinery, an industrial machinery or the like by a seal lip.

2. Description of the Conventional Art

As a sealing device sealing an outer periphery of a rotating body by a seal lip, an oil seal has been known. FIG. 6 is a half sectional view showing an oil seal as a conventional sealing device by cutting it along a plane passing through an axis O thereof.

An oil seal 100 shown in FIG. 6 is formed in an annular shape by a rubber-like elastic material, and is structured such that an attaching portion 101 at an outer periphery and a seal lip 103 at an inner peripheral side thereof are formed continuously with each other via a lip holder portion 102, and a metal ring 104 for reinforcing is integrally embedded from the attaching portion 101 to the lip holder portion 102. Further, an outer periphery of the seal lip 103 is formed in a groove shape which is continuous in a circumferential direction, and a garter spring 105 for compensating for tension force of the seal lip 103 is fitly attached.

Further, in the oil seal 100, the attaching portion 101 is closely fitted to an inner peripheral surface of the housing 110, and a distal end inner peripheral portion of the seal lip 103 oriented to an in-machine A side is slidably brought into close contact with an outer peripheral surface of a rotating shaft 120 inserted into the housing 110, whereby the oil seal 100 achieves a shaft sealing function, and prevents a lubricating oil in the in-machine A side from leaking out of a shaft periphery to a machine outside B.

In this kind of oil seal 100, lubrication of a sliding portion of the seal lip 103 with respect to the outer peripheral surface of the rotating shaft 120 depends on lubricating oil to be sealed in the in-machine A side. However, in the case of being used under an environment of a high peripheral speed and a high temperature, it is necessary to supply more lubricating oil to the vicinity of the seal lip 103 for the purpose of cooling the seal lip 103. Accordingly, as described in the following patent documents, there has been conventionally a structure in which lubricating oil passing through a bearing in an in-machine side is supplied to the vicinity of a seal lip on the basis of centrifugal force, however, a supply efficiency is low and a cooling of the seal lip is not necessarily sufficient.

### SUMMARY OF THE INVENTION

### Problem to be Solved by the Invention

The present invention is made by taking the points mentioned above into consideration, and a technical problem of the present invention is to provide a sealing device which sufficiently supplies lubricating oil to a sliding portion of a seal lip, whereby it is possible to suppress heat generation and abrasion of the seal lip.

### Means for Solving the Problem

As a means for effectively solving the technical problem mentioned above, in accordance with the present invention, there is provided a sealing device comprising a sealing device main body in which a seal lip oriented to an in-machine side is slidably brought into close contact with an outer peripheral surface of a rotating body, and a pumping device provided in combination with the sealing device main body, wherein the pumping device has a helical groove, which is positioned at the in-machine side of the seal lip, is formed in a surface opposed to an outer peripheral surface of the rotating body and feeds fluid to the seal lip side on the basis of rotation of the rotating body, and discharge flow passages which make a space between the sealing device main body and the pumping device communicate with the machine inside side.

In accordance with the structure mentioned above, since the helical groove of the pumping device feeds the lubricating oil in the in-machine side to the seal lip side (the space between the sealing device main body and the pumping device) on the basis of the rotation of the rotating body, the sliding portion between the seal lip and the rotating body is lubricated. Further, the lubricating oil is reflowed to the in-machine side from the space between the sealing device main body and the pumping device via the discharge flow passages. Accordingly, a flow in one direction of the lubricating oil is generated, thereby preventing the lubricating oil from being deteriorated and being raised in its oil temperature due to retention of the lubricating oil, and a cooling efficiency of the seal lip is improved.

### EFFECT OF THE INVENTION

In accordance with the sealing device of the present invention, since the lubricating oil is supplied at a sufficient flow rate to the sliding portion of the seal lip, it is possible to efficiently cool the seal lip as well as to suppress abrasion of the seal lip. As a result, a good sealing function can be maintained over a long term.

### BRIEF EXPLANATION OF DRAWINGS

FIG. 1 is a half sectional view showing a first embodiment of a sealing device in accordance with the present invention by cutting it along a plane passing through an axis O;

FIG. 2 is a sectional view of a substantial part showing a variation of a sectional shape of a helical groove in a pumping device used in the present invention;

FIG. 3 is a sectional view showing a second embodiment of the sealing device in accordance with the present invention by cutting it along a plane passing through an axis O;

FIG. 4 is a half sectional view showing a third embodiment of the sealing device in accordance with the present invention by cutting it along a plane passing through an axis O;

FIG. 5 is a partial sectional view showing a specific example of the sealing device in accordance with the present invention by cutting it along a plane passing through an axis O; and

FIG. 6 is a half sectional view showing an oil seal as a conventional sealing device by cutting it along a plane passing through an axis O.

### DETAILED DESCRIPTION OF PREFERRED EMBODIMENT

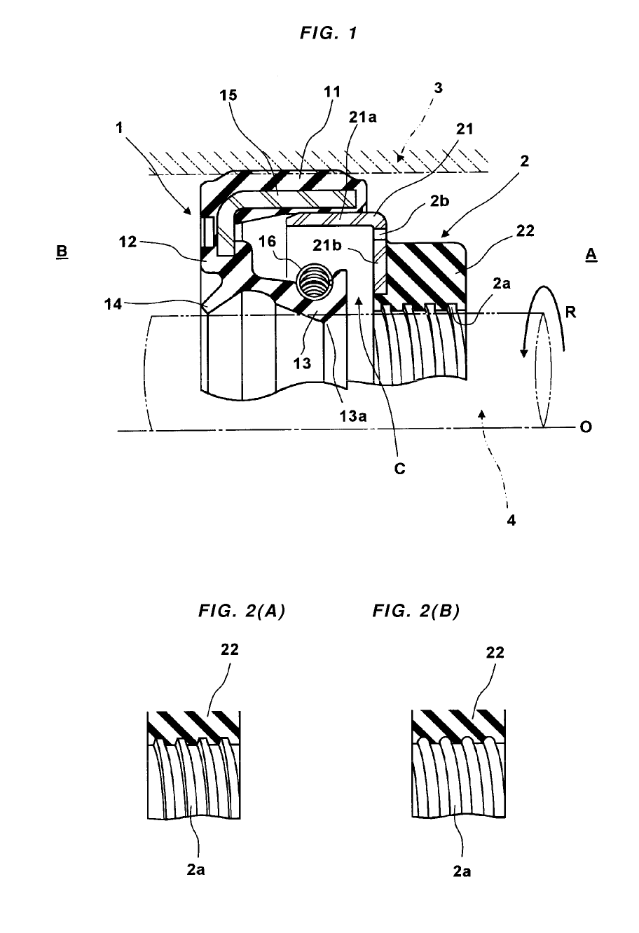

A description will be given below of preferred embodiments of a sealing device in accordance with the present invention with reference to the accompanying drawings. FIG. 1 is a half sectional view showing a first embodiment of a sealing device in accordance with the present invention by cutting it along a plane passing through an axis O, and FIG. 2 is a sectional view of a substantial part showing a variation of a sectional shape of a helical groove in a pumping device used in the present invention.

First of all, in FIG. 1, reference numeral 3 denotes a housing of an equipment, and reference numeral 4 denotes a rotating shaft inserted to an inner periphery of the housing 3. The sealing device in accordance with the first embodiment is constructed by a sealing device main body 1 in which a seal lip 13 oriented to an in-machine A side is slidably brought into close contact with an outer peripheral surface of the rotating shaft 4, and a pumping device 2 provided in combination with the sealing device main body 1. In this case, the rotating shaft 4 corresponds to a rotating body described in claim 1.

The sealing device main body 1 is provided with a configuration for serving as a so-called oil seal, and is integrally formed in a metal ring 15 by a rubber material or a synthetic resin material having a rubber-like elasticity. In other words, the sealing device main body 1 has an approximately cylindrical attaching portion 11, a lip holder portion 12 extending to an inner peripheral side from an end portion at an out-machine B side, a seal lip 13 extending toward the in-machine A side from a radially inner end of the lip holder portion 12 in such a manner as to form an approximately C-shaped cross section together with the attaching portion 11 and the lip holder portion 12, a dust lip 14 extending toward an opposite side to the seal lip 13 (out-machine B side) from an inner peripheral end of the lip holder portion 12, a reinforcing metal ring 15 embedded in both the attaching portion 11 and the lip holder portion 12, and a garter spring 16 fitly attached to the seal lip 13.

The attaching portion 11 in the sealing device main body 1 is a portion which is pressed into and closely fitted to an inner peripheral surface of the housing 3, and is structured such as to be properly compressed in a radial direction between the metal ring 15 and the inner peripheral surface of the housing 3 in the state of installation.

A seal edge 13a having an approximately V-shaped cross section is formed on an inner periphery in the vicinity of a distal end portion of the seal lip 13 in the sealing device main body 1, and the seal edge 13a is structured such as to be slidably brought into close contact with an outer peripheral surface of the rotating shaft 4 with a suitable fastening margin. On the other hand, the dust lip 14 oriented to an opposite side to the seal lip 13 is structured such that an inner peripheral edge thereof comes close to the outer peripheral surface of the rotating shaft 4 with a micro gap, or is slidably brought into close contact with a slight fastening margin.

The garter spring 16 is made by metal coil springs being annularly connected, is fitly attached to an annular groove formed at the outer peripheral side of the seal edge 13a in the seal lip 13, and is structured such as to compensate for tension force of the seal lip 13 with respect to the outer peripheral surface of the rotating shaft 4.

The pumping device 2 is constructed by a metal ring 21, and a helical pump portion 22 integrally provided therein. Describing in detail, the metal ring 21 in the pumping device 2 is constructed by a fitted tube portion 21a which is pressed into and fitted to an inner peripheral surface of the attaching portion 11 in the sealing device main body 1, and a flange portion 21b which extends in a radially inward direction from an end portion at the in-machine A side thereof and has a larger inner diameter than the diameter of the rotating shaft 4, and the helical pump portion 22 is formed in an annular shape on the flange portion 21b by a rubber material, a synthetic resin material having a rubber-like elasticity or a synthetic resin material having no rubber-like elasticity. In other words, the pumping device 2 is previously integrally attached to the attaching portion 11 of the sealing device main body 1 in accordance with press fitting.

The helical pump portion 22 in the pumping device 2 is structured such that a helical groove 2a feeding fluid to the seal lip 13 side in the sealing device main body 1 on the basis of rotation in a direction R of the rotating shaft 4 is formed in an inner peripheral surface which is close to and is opposed to the outer peripheral surface of the rotating shaft 4. Further, discharge flow passages 2b making a space C between the sealing device main body 1 and the pumping device 2 communicate with the in-machine A side are provided at a plurality of positions in a circumferential direction in a radially outer portion of the flange portion 21b of the metal ring 21, which is exposed outside the helical pump portion 22.

In this case, when an angle of the helical groove 2a with respect to a rotating direction of the rotating shaft 4 is defined to θ, it is preferable to satisfy the relation of 0<θ≦45 degree.

Further, as for a sectional shape of the helical groove 2a, there can be thought a trapezoidal shape as shown in FIG. 2A and a semicircular shape as shown in FIG. 2B in addition to a rectangular shape as shown in FIG. 1, and it is not particularly limited.

On the basis of the sealing device in accordance with the first embodiment structured as mentioned above, the sealing device main body 1 is structured such that the attaching portion 11 is pressed into and fitted to the inner peripheral surface of the housing 3 in such a manner that the seal lip 13 is oriented to the in-machine A side, and the seal edge 13a of the inner periphery of the seal lip 13 is slidably brought into close contact with the outer peripheral surface of the rotating shaft 4. Further, the pumping device 2 previously attached to the sealing device main body 1 comes to a state of being arranged at the in-machine A side of the sealing device main body 1.

In such the installed state of the sealing device main body 1, the seal edge 13a of the seal lip 13 is slidably brought into close contact with the outer peripheral surface of the rotating shaft 4, whereby lubricating oil supplied for lubricating, for example, a bearing (not shown) or the like in the in-machine A side is prevented from leaking to atmospheric air at the out-machine B side from a shaft periphery of the rotating shaft 4, and a foreign material in the atmospheric air at the out-machine B side is prevented from making an intrusion by means of the dust lip 14.

Further, since the pumping device 2 achieves a helical pump function of discharging fluid interposed between the rotating shaft 4 and the helical groove 2a of the helical pump portion 22 to the seal lip 13 side on the basis of the rotation of the rotating shaft 4, that is, the lubricating oil in the in-machine A side is forcibly fed to the seal lip 13 through the helical groove 2a, a sliding portion between the seal lip 13 and the rotating shaft 4 is well lubricated.

Further, the lubricating oil supplied to the sliding portion between the seal lip 13 and the rotating shaft 4 is reflowed to the in-machine A side from the space C between the sealing device main body 1 and the pumping device 2 via the discharge flow passages 2b provided in a radially outer portion of the flange portion 21b of the metal ring 21. Accordingly, since a flow in one direction heading for the discharge flow passages 2b from the inner periphery of the helical pump portion 22 via the sliding portion between the seal lip 13 and the rotating shaft 4 is generated in the space C between the sealing device main body and the pumping device 2, it is possible to prevent the lubricating oil from being deteriorated due to its retention and prevent an oil temperature from rising, and the seal lip 13 can be efficiently cooled.

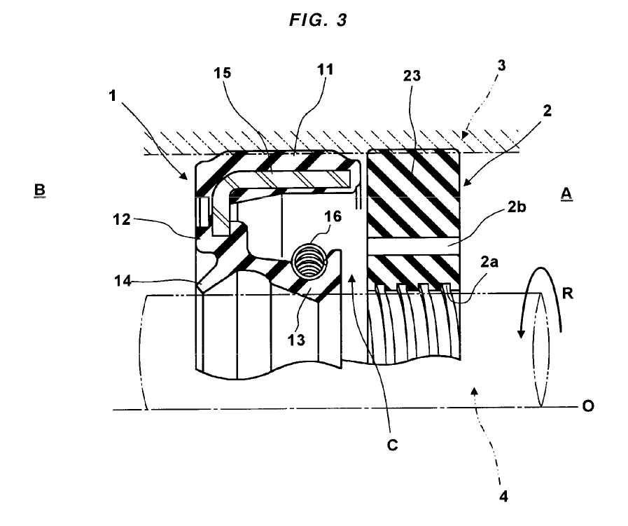

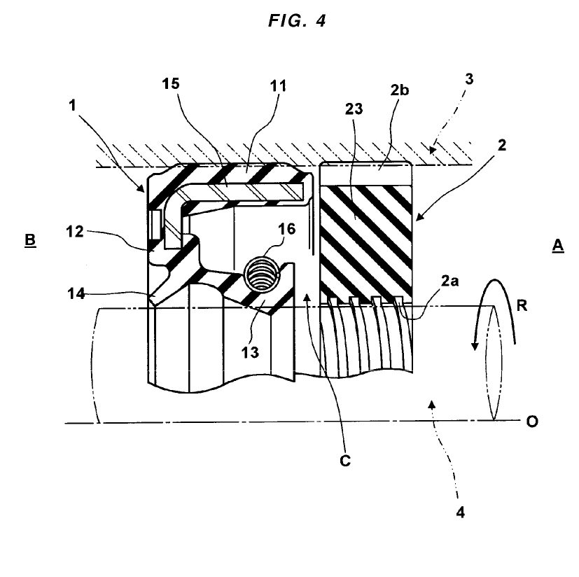

Next, FIG. 3 is a half sectional view showing a second embodiment of the sealing device in accordance with the present invention by cutting it along a plane passing through an axis O, and FIG. 4 is a half sectional view showing a third embodiment of the sealing device in accordance with the present invention by cutting it along a plane passing through an axis O.

In these embodiments, a difference from the first embodiment shown in FIG. 1 exists in a point that the pumping device 2 is constructed only by a pumping ring 23 which is formed by a rubber material, a synthetic resin material having a rubber-like elasticity or a synthetic resin material having no rubber-like elasticity, is provided in combination at the in-machine A side of the sealing device main body 1 and is attached to the inner peripheral surface of the housing 3 in accordance with a press fitting.

The pumping ring 23 is structured such that a helical groove 2a for feeding fluid to the seal lip 13 side in the sealing device main body 1 on the basis of rotation in a direction R of the rotating shaft 4 is formed in an inner peripheral surface which is close to and is opposed to the outer peripheral surface of the rotating shaft 4, and discharge flow passages 2b making a space C between the sealing device main body 1 and the pumping device 2 communicate with the in-machine A side are provided at a plurality of positions in a circumferential direction, in the pumping ring 23.

In the second embodiment shown in FIG. 3, the discharge flow passages 2b are constructed by a plurality of holes passing through the pumping ring 23 in an axial direction, and in the third embodiment shown in FIG. 4, the discharge flow passages 2b are formed between a plurality of grooves extending in an axial direction along an outer peripheral surface of the pumping ring 23 and the inner peripheral surface of the housing 3.

In this case, the sealing device main body 1 is provided basically with the same structure as that of the first embodiment (FIG. 1) which has been previously described.

On the basis of the sealing device in accordance with the second or third embodiment structured as mentioned above, the sealing device main body 1 is structured such that the attaching portion 11 is pressed into and fitted to the inner peripheral surface of the housing 3 in such a manner that the seal lip 13 is oriented to the in-machine A side, and the seal edge 13a on the inner periphery of the seal lip 13 is slidably brought into close contact with the outer peripheral surface of the rotating shaft 4. Further, the pumping device 2 (the pumping ring 23) is positioned at the in-machine A side of the sealing device main body 1 so as to be pressed into and fitted to the inner peripheral surface of the housing 3.

In such the installed state of the sealing device main body 1, lubricating oil supplied for lubricating, for example, a bearing (not shown) or the like in the in-machine A side is prevented from leaking to atmospheric air at the out-machine B side from a shaft periphery of the rotating shaft 4 by means of the seal lip 13, and a foreign material in the atmospheric air at the out-machine B side is prevented from making an intrusion by means of the dust lip 14, in the same manner as that of the first embodiment.

Further, since the pumping device 2 achieves a helical pump function of discharging fluid interposed between the rotating shaft 4 and the helical groove 2a of the pumping ring 23 to the seal lip 13 side on the basis of the rotation of the rotating shaft 4, that is, the lubricating oil in the in-machine A side is forcibly fed to the seal lip 13 through the helical groove 2a, a sliding portion between the seal lip 13 and the rotating shaft 4 is well lubricated.

Further, the lubricating oil supplied to the sliding portion between the seal lip 13 and the rotating shaft 4 is reflowed to the in-machine A side from the space C between the sealing device main body 1 and the pumping device 2 via the discharge flow passages 2b. Accordingly, since a flow in one direction heading for the discharge flow passages 2b from the inner periphery of the pumping ring 23 via the sliding portion between the seal lip 13 and the rotating shaft 4 is generated in the space C between the sealing device main body 1 and the pumping device 2, it is possible to prevent the lubricating oil from being deteriorated due to its retention and prevent an oil temperature from rising, and the seal lip 13 can be efficiently cooled.

### Example

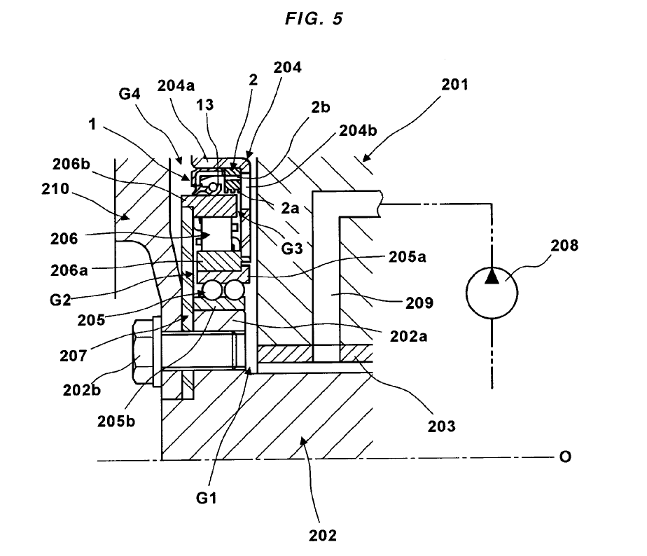

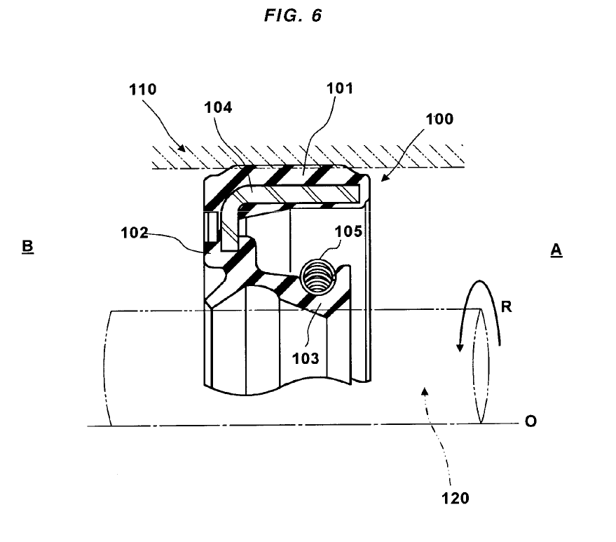

FIG. 5 is a partial sectional view showing a specific example of the sealing device in accordance with the present invention by cutting it along a plane passing through an axis O. In this FIG. 5, reference numeral 201 denotes a cylinder block of an internal combustion engine, reference numeral 202 denotes an output shaft which is supported to the cylinder block 201 via a first bearing 203 in a rotatable state, and reference numeral 204 denotes a ring gear which is provided on a shaft end of the output shaft 202 so as to be relatively rotatable with the output shaft 202 via a second bearing 205. Describing in detail, an outer ring 205a of the second bearing 205 is fixed to an inner portion of the ring gear 204, an inner ring 205b of the second bearing 205 is fixed to an outer peripheral surface of a flange 202a formed on the shaft end of the output shaft 202, and the ring gear 204 is engaged with a pinion gear of a starting motor (not shown).

Further, a one way clutch 206 transmitting a rotating force only to the output shaft 202 from the ring gear 204 is interposed between the ring gear 204 and the output shaft 202. Describing in detail, an inner race 206a of the one way clutch 206 is fixed to an inner portion of the ring gear 204, and an outer race 206b of the one way clutch 206 is fixed to the output shaft 202 via a coupling plate 207 which is attached to the flange 202a on the shaft end thereof together with a flywheel 210 by a bolt 202b.

In other words, at a time of starting of the internal combustion engine, if the ring gear 204 is rotated by the starting motor (not shown), rotating force thereof is transmitted to the output shaft 202 from the one way clutch 206, whereby driving of the internal combustion engine is started. Further, an engagement of the one way clutch 206 is released at a time point when the rotating speed of the output shaft 202 increases beyond the rotating speed of the ring gear 204, the starting motor is stopped at a time point when the rotating speed of it increases up to a predetermined rotating speed, and the ring gear 204 stops.

Further, lubricating oil is supplied to the sliding portion between the first bearing 203 and the output shaft 202 from an oil pan (not shown) through an oil passage 209 by a hydraulic pump 208, a part of the lubricating oil flows out in an outward radial direction through a gap G1 between the flange 202a of the output shaft 202 and the cylinder block 201, further a part thereof is supplied to the second bearing 205, and the lubricating oil passing through a portion between the outer ring 205a and the inner ring 205b of the second bearing 205 flows out further in the outward radial direction from a gap G2 between the coupling plate 207 and the second bearing 205 on the basis of centrifugal force, and is supplied to the sliding portion of the one way clutch 206.

In order to prevent the lubricating oil flowing out in the outward radial direction through the gap G1 between the flange 202a of the output shaft 202 and the cylinder block 201, and the lubricating oil supplied to the second bearing 205 and the one way clutch 206 from the gap G1 from flowing further to the out-machine side from a gap G3 between the outer race 206b of the one way clutch 206 and the ring gear 204 via a space in an outer peripheral side of the outer race 206b and a gap G4 between the ring gear 204 and the flywheel 210, and securely collect the lubricating oil into the oil pan (not shown), a sealing device is provided between the outer race 206b of the one way clutch 206 and a cylindrical housing 204a positioned at an outer peripheral side thereof and formed in the ring gear 204. The structure in accordance with the present invention can be preferably applied to this sealing device. In other words, the sealing device in this example is provided with the sealing device main body 1, and the pumping device 2 provided in combination in the axial direction with the sealing device main body 1, and they are both attached to an inner peripheral surface of the housing 204a.

Describing in detail, the sealing device main body 1 has the seal lip 13 oriented to the in-machine side (the cylinder block 201 side), and the seal lip 13 is slidably brought into close contact with an outer peripheral surface of the outer race 206b corresponding to the rotating body. On the other hand, the pumping device 2 is positioned at the cylinder block 201 side of the seal lip 13, the helical groove 2a feeding the fluid to the seal lip 13 side on the basis of the rotation of the outer race 206b is formed in an inner peripheral surface opposed to the outer peripheral surface of the outer race 206b, and the discharge flow passages 2b making the space between the sealing device main body 1 and the pumping device 2 communicate with the space at the cylinder block 201 side via window portions 204b provided in the ring gear 204 are provided.

In this case, as has been described previously, since the ring gear 204 stops after the internal combustion engine is started by the starting motor (not shown), the lubricating oil has been conventionally hard to be supplied to the sliding portion between the seal lip 13 and the outer peripheral surface of the outer race 206b. However, if the structure in accordance with the present invention is applied, the helical groove 2a of the pumping device 2 achieves the helical pump function of feeding the lubricating oil passing through the second bearing 205 and the one way clutch 206 and reaching the inner periphery of the pumping device 2 from the gap G3 between the outer race 206b of the one way clutch 206 and the ring gear 204 to the seal lip 13 side on the basis of the rotation of the outer race 206b, and the sliding portion between the seal lip 13 and the outer race 206b is accordingly lubricated well.

Further, the lubricating oil supplied to the sliding portion between the seal lip 13 and the outer race 206b is reflowed to the in-machine side from the space between the sealing device main body 1 and the pumping device 2, via the discharge flow passages 2b and the window portions 204b of the ring gear 204. Accordingly, it is possible to prevent the lubricating oil from being deteriorated due to the retention and prevent the oil temperature from rising, and the seal lip 13 is efficiently cooled.

What is claimed is:

1. A sealing device comprising a sealing device main body in which a seal lip oriented to an in-machine side is slidably brought into close contact with an outer peripheral surface of a rotating body, and a pumping device provided in combination with the sealing device main body, wherein the pumping device has a helical groove which is positioned at the in-machine side of said seal lip, is formed in a surface opposed to an outer peripheral surface of said rotating body and feeds fluid to said seal lip side on the basis of rotation of said rotating body, and discharge flow passages which make a space between said sealing device main body and the pumping device communicate with said in-machine side.
